(19) United States
(12) Patent Application Publication
(10) Pub. No.: US 2026/0168525 A1
(43) Pub. Date: Jun. 18, 2026

(54) FASTENER VERIFICATION SYSTEM

(71) Applicant: GM Global Technology Operations LLC, Detroit, MI (US)

(72) Inventor: Thomas Welsh, Plymouth, MI (US)

(21) Appl. No.: 18/982,374

(22) Filed: Dec. 16, 2024

(51) Int. Cl. F16B 21/08

(52) U.S. Cl. CPC F16B 21/084; F16B 2200/95

(57) ABSTRACT

A fastener verification system for determining proper installation of a fastener to a substrate includes a housing and a spring pin mechanism. The housing includes a connective portion, an exposed portion, and a shroud. The shroud is disposed between the connective portion and the exposed portion. The shroud defines a bore that extends from a top surface to a bottom surface. The spring pin mechanism includes an outer end, a planar middle portion, a hinge, and a pin. The outer end is disposed within the exposed portion. The planar middle portion is disposed between the outer end and the hinge. The hinge is disposed between the planar middle portion and the pin. The pin is disposed within the bore of the shroud. Installation of the fastener is proper when the pin is exposed outside of the top surface. Installation is improper when the pin is entirely disposed within the bore.

### INTRODUCTION

The present disclosure relates to a fastener verification system. More particularly, the present disclosure relates to a fastener verification system attached to a fastener to test proper installation of the fastener.

In various industrial settings, fasteners are used to secure an object to a substrate. For example, the fastener may secure a wire harness to a portion of a motor vehicle by connecting the fastener to the substrate. When the fastener is installed properly to the substrate, the fastener ensures functionality and structural integrity of secured object. However, if the fastener is not installed properly, the connection between the substrate and the fastener could fail.

Thus, to ensure proper installation of the fastener, there is a need for a fastener verification system and method for determining proper installation of the fastener.

### SUMMARY

According to several aspects, a fastener verification system for determining proper installation of a fastener to a substrate is provided. The fastener verification system includes a housing. The housing includes a connective portion. The connective portion has a slot sized to receive the fastener. The housing further includes an exposed portion opposite the connective portion. The exposed portion defines a window. The housing further includes a shroud disposed between the connective portion and the exposed portion. The shroud defining a bore that extends from an upper opening of a top surface of the housing to a bottom surface of the housing. The fastener verification system further includes a spring pin mechanism. The spring pin mechanism includes an outer end disposed within the window of the exposed portion. The spring pin mechanism further includes a planar middle portion disposed between the outer end and a hinge. The spring pin mechanism further includes the hinge connected between the planar middle portion and the pin. The fastener verification system is disengaged when the pin is entirely disposed within the bore of the shroud. The fastener verification system is engaged when the pin is exposed outside of the upper opening of the shroud.

In an additional aspect of the present disclosure, installation of the fastener to the substrate creates a contact pressure from the substrate against the bottom surface of the housing and against the hinge. The contact pressure from the substrate against the hinge pushes the hinge and creates a movement of the pin within the bore.

In another aspect of the present disclosure, the movement of the pin is towards the upper opening of the shroud.

In another aspect of the present disclosure, the movement of the pin exposes the pin outside of the upper opening of the shroud.

In another aspect of the present disclosure, the pressure against the hinge further includes creating the movement of the hinge. The hinge moves towards the bottom surface of the housing.

In another aspect of the present disclosure, the exposed portion of the housing further includes a groove. The planar middle portion is disposed within the groove.

In another aspect of the present disclosure, the shroud further includes a lower opening of the bottom surface of the housing. The lower opening matches a contour of the hinge.

In another aspect of the present disclosure, the hinge is disposed in the lower opening when the fastener verification system is engaged.

In another aspect of the present disclosure, the bore of the shroud matches a contour of the pin.

In another aspect of the present disclosure, the bottom surface of the housing is flat.

In another aspect of the present disclosure, the spring pin mechanism is composed of a metal.

In another aspect of the present disclosure, the outer end of the spring pin mechanism further includes a bulge. The bulge extends through the window of the exposed portion of the housing.

In another aspect of the present disclosure, the fastener verification system further incudes attaching an electrical continuity tester to the fastener verification system. A first wire of the electrical continuity tester is attached to the pin and a second wire of the electrical continuity tester is attached to the exposed portion of the housing.

In another aspect of the present disclosure, the electrical continuity tester further includes sending an electrical current through the fastener verification system and detecting continuity.

In another aspect of the present disclosure, the fastener verification system further includes classifying an installation of the fastener to the substrate as proper.

In another aspect of the present disclosure, the fastener verification system further includes classifying the installation of the fastener. The installation is classified as improper when the fastener verification system is disengaged. The installation is classified as proper when the fastener verification system is engaged.

According to several aspects, a fastener verification system for determining proper installation of a fastener to a substrate is provided. The fastener verification system includes a housing. The housing includes a connective portion having a slot sized to receive the fastener. The housing further includes an exposed portion opposite the connective portion. The exposed portion includes a window connecting to an outer end. The exposed portion further includes a groove connecting to a planar middle portion. The housing further includes a shroud disposed between the connective portion and the exposed portion. The shroud defines a bore that extends from a top surface of the housing to a bottom surface of the housing. The bore matches a contour of a pin. The top surface defines an upper opening. The bottom surface defines a lower opening. The fastener verification system further includes a spring pin mechanism. The spring pin mechanism includes the outer end. The outer end includes a bulge extended through the window of the exposed portion. The spring pin mechanism further includes the planar middle portion. The planar middle portion is connected between the outer end and a hinge. The spring pin mechanism further includes the pin disposed within the bore of the shroud. The spring pin mechanism further includes the hinge connected between the planar middle portion and the pin. The fastener verification system is disengaged when the pin is entirely disposed within the shroud. The fastener verification system is engaged when the pin is exposed outside of the upper opening of the shroud.

According to several aspects, a method for verifying proper installation of a fastener to a substrate is provided. The method includes attaching a fastener verification system to a fastener. The fastener verification system includes a housing. The housing includes a connective portion having a slot sized to receive the fastener. The housing further includes an exposed portion opposite the connective portion. The exposed portion has a window. The housing further includes a shroud disposed between the connective portion and the exposed portion. The shroud defines a bore that extends from an upper opening of a top surface of the housing to a bottom surface of the housing. The fastener verification system further includes a spring pin mechanism. The spring pin mechanism includes an outer end disposed within the window of the exposed portion. The spring pin mechanism further includes a pin disposed within the bore of the shroud. The spring pin mechanism further includes a planar middle portion connected between the outer end and a hinge. The spring pin mechanism further includes the hinge connected between the planar middle portion and the pin. The method further includes installing the fastener to the substrate. Installing the fastener applies a pressure from the substrate against the hinge of the spring pin mechanism. Applying the pressure against the hinge creates movement of the hinge and the pin. The method further includes verifying proper installation of the fastener to the substrate.

In another aspect of the present disclosure, the method further includes conducting an electrical continuity test by attaching a tester to the fastener verification system. The tester includes a first wire. The first wire attaches to the pin. The tester further includes a second wire. The second wire attaches to the exposed portion of the housing. The tester sends an electrical current through the first wire and the second wire. The electrical continuity test detects continuity of the electrical current. Proper installation of the fastener is detected.

In another aspect of the present disclosure, the method further includes conducting a visual test. The pin is visible outside of the opening of the shroud. Proper installation of the fastener is detected.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an isometric view of a fastener verification system attached to a fastener according to an exemplary embodiment.

FIG. 2 is an isometric view of the fastener verification system according to an exemplary embodiment.

FIG. 3 is cross-section view of a housing of the fastener verification system according to an exemplary embodiment.

FIG. 4 is an enlarged view of a spring pin mechanism of the fastener verification system according to an exemplary embodiment.

FIG. 5 is a cross-section view of the fastener verification system in a disengaged position according to an exemplary embodiment.

FIG. 6 is a cross-section view of the fastener verification system in an engaged position according to an exemplary embodiment.

### DETAILED DESCRIPTION

The following description is merely exemplary in nature and is not intended to limit the present disclosure, application, or uses.

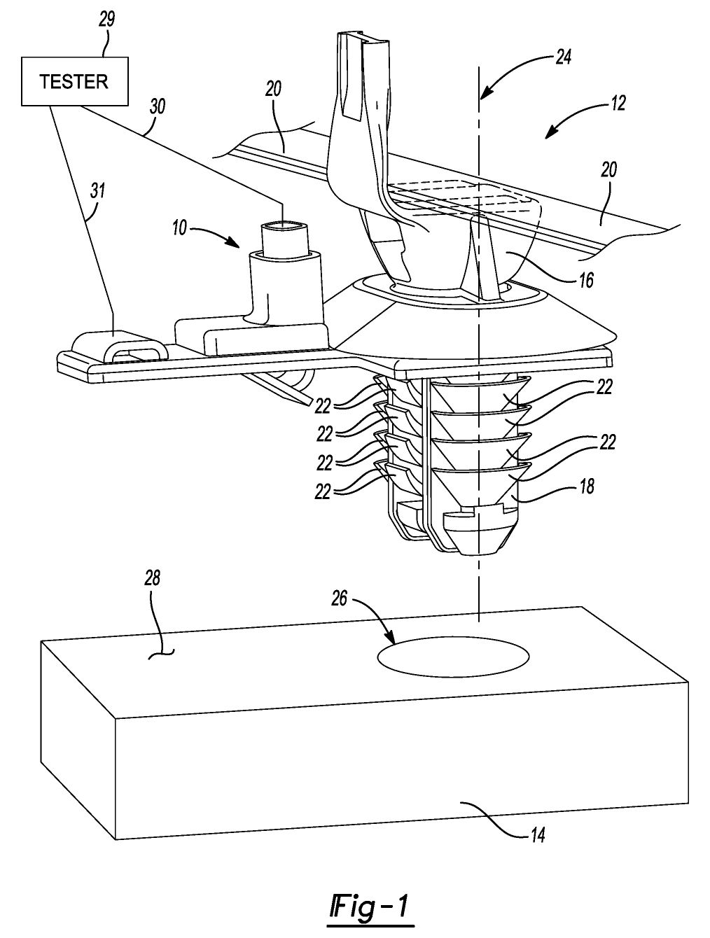

Referring to FIG. 1, a fastener verification system 10 attached to a fastener 12 and a substrate 14 is illustrated. The fastener verification system 10 may be attached to the fastener 12 through various means, including welding or an adhesive. The fastener verification system 10 detects proper installation of the fastener 12 to the substrate 14. The fastener 12 may be a fir tree clip, a plastic rivet, or a push-in fastener. Examples of the substrate 14 include, but are not limited to, an engine bay, a dashboard, a door panel, a rear compartment, or a roof lining. Proper installation of the fastener 12 to the substrate 14 ensures the functionality and structural integrity of the substrate 14.

The fastener 12 includes a head 16 and a barbed portion 18. The fastener verification system 10 is attached to the fastener 12 and is disposed between the head 16 and the barbed portion 18. In the example provided, the head 16 holds a wire harness 20 in place. However, it should be appreciated that the fastener 12 may be used to fasten any number of objects without departing from the scope of the present disclosure. Pressure is applied to the head 16 to push the barbed portion 18 into the substrate 14, installing the fastener 12. The barbed portion 18 includes flexible ribs 22. During installation, the substrate 14 applies pressure against the flexible ribs 22, causing the flexible ribs 22 to flex inwards towards a fastener central axis 24. Once the barbed portion 18 is fully inserted into the substrate 14 the pressure applied against the flexible ribs 22 decreases, causing the flexible ribs 22 to flex outwards away from the fastener central axis 24 and returning to the original state of the flexible ribs 22. The fully inserted barbed portion 18 creates a secure hold with the substrate 14, preventing the fastener 12 from being easily removed from the substrate 14.

The substrate 14 defines a hole 26 on a substrate surface 28. The fastener 12 is installed by inserting the barbed portion 18 into the hole of the substrate 14. Proper installation of the fastener 12 to the substrate 14 creates pressure from the substrate surface 28 against the fastener verification system 10. The pressure against the fastener verification system 10 detection of proper installation of the fastener 12 to the substrate 14, as will be described below.

To detect proper installation of the fastener 12 to the substrate 14, an electrical continuity test and/or a visual test can be performed. The electrical continuity test is performed by connecting a tester 29 to the fastener verification system 10. The tester 29 includes a first wire 30 and a second wire 31. The first wire 30 and the second wire 31 are connected to opposite ends of the fastener verification system 10. The tester 29 sends an electrical current through the first wire 30 and the second wire 31. When the tester 29 detects continuity of the electrical current, the fastener 12 is installed to the substrate 14 properly. When the tester does not detect continuity of the electrical current, the fastener 12 is not installed to the substrate 14 properly. The visual test is described in further detail below.

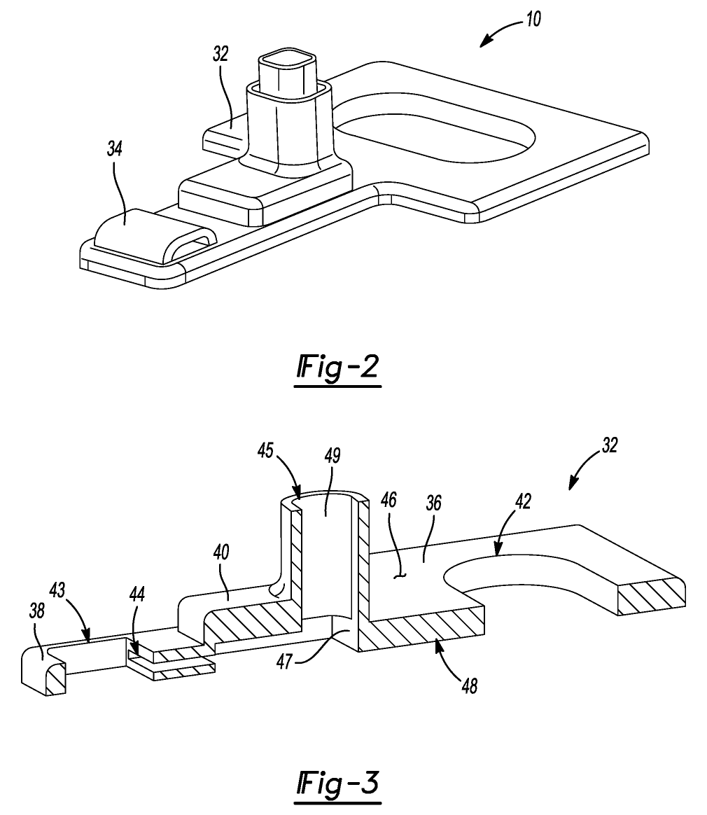

Referring to FIG. 2, the fastener verification system 10 is illustrated. The fastener verification system 10 detects proper installation of the fastener 12 to the substrate 14. To detect proper installation, a visual test or an electrical test can be conducted. The fastener verification system includes a housing 32 and a spring pin mechanism 34.

Referring to FIG. 3, a cross-section of the housing 32 is illustrated. The housing 32 is composed of a plastic. The housing 32 includes a connective portion 36, an exposed portion 38, and a shroud 40. The connective portion 36 defines a slot 42 sized to receive the fastener 12 (shown in FIG. 1). The exposed portion 38 is opposite of the connective portion 36. A window 43 and a groove 44 are disposed on the exposed portion 38. The shroud 40 is disposed between the connective portion 36 and the exposed portion 38. The shroud 40 defines an upper opening 45 in the top surface 46 of the housing 32 and a lower opening 47 in the bottom surface 48 of the housing 32. The upper opening 45 communicates with the lower opening 47 through a bore 49 in the shroud 40. The groove 44 extends from the window 43 through the shroud 40 to the bore 49 and the lower opening 47. The lower opening 47 is disposed within the shroud 40 to accommodate a portion of the spring pin mechanism 34, as will be described in greater detail below.

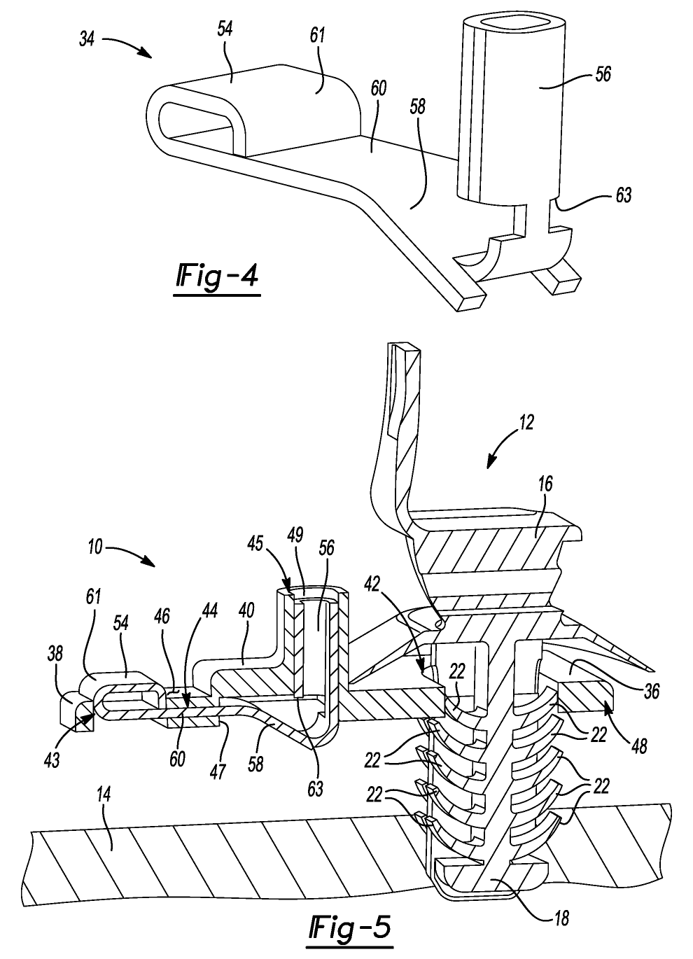

Referring to FIG. 4, the spring pin mechanism 34 is illustrated. The spring pin mechanism is composed of a metal. The spring pin mechanism 34 includes an outer end 54, a pin 56, and a hinge 58. The outer end 54 has a bulge 61 that extends away from a planar middle portion 60. The pin 56 is opposite of the outer end 54. The hinge 58 is between the planar middle portion 60 and the pin 56. The hinge 58 connects to a bottom edge 63 of the pin 56, creating a downward slope away from the planar middle portion 60 and the bottom surface 48 of the housing 32 (shown in FIG. 5) when the pin is disposed within the housing 32.

Pressure is applied against the hinge 58 during installation of the fastener 12 to the substrate14. The pressure against the hinge 58 causes the downward slope to diminish, creating a flat surface with the outer end 54. The hinge 58 connects to the pin 56 and the application of pressure against the hinge 58 creates movement in the pin 56.

Referring to FIG. 5, a cross-section view of the fastener verification system 10 with the fastener 12 in a disengaged position to the substrate 14 is illustrated. The connective portion 36 is attached to the fastener 12 between the head 16 and the barbed portion 18 of the fastener 12.

The spring pin mechanism 34 connects to the housing 32 to create the fastener verification system 10. The exposed portion 38 of the housing 32 is connected to the outer end 54 of the spring pin mechanism 34. The bulge 61 of the outer end 54 extends through the window 43 of the exposed portion 38, connecting the housing 32 to the spring pin mechanism 34. The planar middle portion 60 of the hinge 58 is disposed within the groove 44 of the housing 32. The pin 56 is disposed within the bore 49 of the shroud 40. The hinge 58 extends from the lower opening 47 in the bottom surface 48 of the housing 32. The bore of the shroud 40 matches the contour of the pin 56.

The fastener verification system 10 detects improper installation of the fastener 12 to the substrate 14 through the means of the electrical continuity test or the visual test. The electrical continuity test and the visual test detect improper installation when the fastener verification system 10 is disengaged. The fastener verification system 10 is disengaged when the pin 56 is hidden within the shroud 40 of the housing 32.

The electrical continuity test cannot be performed when the pin 56 is hidden within the shroud 40 of the housing 32. To perform the electrical continuity test, the first wire 30 of the tester 29 (shown in FIG. 1) is attached to the pin 56. If the pin 56 is hidden within the shroud 40, the first wire 30 (shown in FIG. 1) cannot connect to the pin 56 and the electrical continuity test cannot be conducted, indicating improper installation of the fastener 12. Additionally, the visual test is conducted by determining if the pin 56 is visible outside of the shroud 40. If the pin 56 is hidden and not visible outside of the shroud 40, improper installation of the fastener 12 is detected.

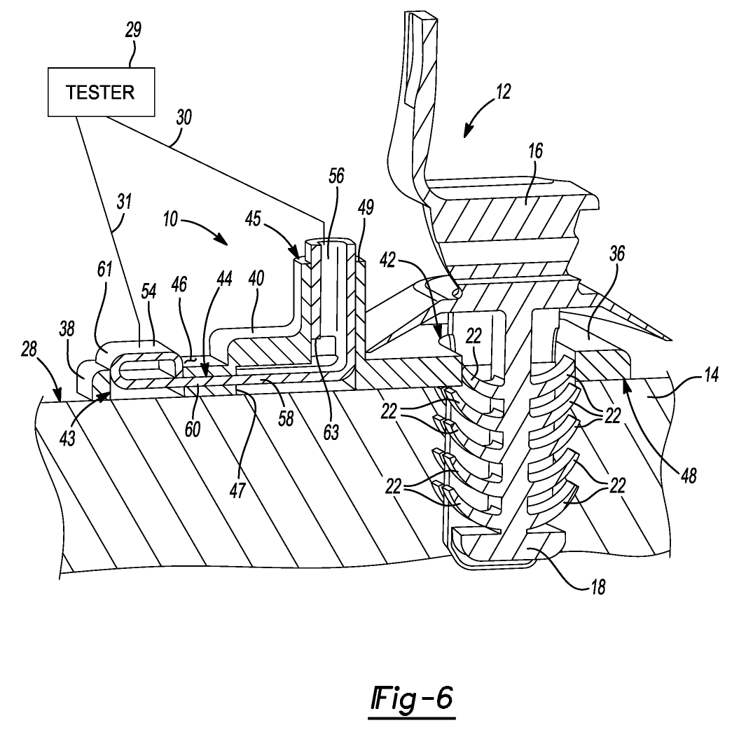

Referring to FIG. 6, a cross-section view of the fastener verification system 10 with the fastener 12 in a fully engaged position to the substrate 14 is illustrated. The fastener verification system 10 is engaged when the pin 56 is exposed outside of upper opening 45 of the shroud 40. The pin 56 becomes exposed outside of the upper opening 45 of the shroud 40 when the hinge 58 is in contact with the substrate surface 28. The contact creates pressure against the hinge 58, causing the hinge 58 to move upwards towards the lower opening 47 of the bottom surface 48 of the housing 32. The lower opening 47 matches a contour of the hinge 58. The hinge 58 becomes flush with the bottom surface 48 of the housing 32, pushing the pin 56 outward towards the upper opening 45 of the shroud 40.

To detect proper installation of the fastener 12, the electrical continuity test or the visual test can be conducted. To conduct the electrical continuity test, the first wire 30 of the tester 29 is attached to the pin 56. The second wire 31 of the tester 29 is attached to the exposed portion 38 of the housing 32. The tester 29 sends an electrical current through the first wire 30 and the second wire 31. Proper installation of the fastener 12 to the substrate 14 is detected when the tester 29 detects continuity of the electrical current. Improper installation of the fastener 12 to the substrate 14 is detected when the tester 29 does not detect continuity of the electrical current.

The visual test can be conducted to detect proper installation of the fastener 12 to the substrate 14. When the pin 56 is visible outside of the upper opening 45 of the shroud 40, proper installation is detected. When the pin 56 is disposed completely within the shroud 40 and not visible outside of the upper opening 45 of the shroud 40, improper installation of the fastener 12 is detected.

The fastener verification system 10 of the present disclosure offers several advantages. For example, the fastener verification system 10 is easily attached to the fastener 12. The fastener verification system 10 can be attached to existing fasteners 12 in the market. Additionally, the fastener verification system allows for fast detection of proper installation of the fastener 12 to the substrate 14. Proper installation of the fastener 12 ensures functionality and structural integrity of the substrate 14.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A fastener verification system for determining proper installation of a fastener to a substrate, the fastener verification system comprising:
a housing including;
a connective portion having a slot sized to receive the fastener therein;
an exposed portion opposite the connective portion, the exposed portion defining a window; and
a shroud disposed between the connective portion and the exposed portion, the shroud defining a bore that extends from an upper opening of a top surface of the housing to a bottom surface of the housing;
a spring pin mechanism including;
an outer end disposed within the window of the exposed portion
a pin disposed within the bore of the shroud;
a planar middle portion disposed between the outer end and a hinge; and
the hinge connected between the planar middle portion and the pin,
wherein the fastener verification system is disengaged when the pin is entirely disposed within the bore of the shroud, and
wherein the fastener verification system is engaged when the pin is exposed outside of the upper opening of the shroud.

2. The fastener verification system of claim 1, wherein installation of the fastener to the substrate creates a contact pressure from the substrate against the bottom surface of the housing and against the hinge, wherein the contact pressure from the substrate against the hinge pushes the hinge and creates a movement of the pin within the bore.

3. The fastener verification system of claim 2, wherein the movement of the pin is towards the upper opening of the shroud.

4. The fastener verification system of claim 3, wherein the movement of the pin exposes the pin outside of the upper opening of the shroud.

5. The fastener verification system of claim 2, wherein the pressure against the hinge further comprises creating the movement of the hinge, wherein the hinge moves towards the bottom surface of the housing.

6. The fastener verification system of claim 1, wherein the exposed portion of the housing further comprises a groove, wherein the planar middle portion is disposed within the groove.

7. The fastener verification system of claim 6, wherein the shroud further comprises a lower opening of the bottom surface of the housing, wherein the lower opening matches a contour of the hinge.

8. The fastener verification system of claim 7, wherein the hinge is disposed in the lower opening when the fastener verification system is engaged.

9. The fastener verification system of claim 1, wherein the bore of the shroud matches a contour of the pin.

10. The fastener verification system of claim 1, wherein the bottom surface of the housing is flat.

11. The fastener verification system of claim 1, wherein the spring pin mechanism is composed of a metal.

12. The fastener verification system of claim 1, wherein the outer end of the spring pin mechanism further comprises a bulge, wherein the bulge extends through the window of the exposed portion of the housing.

13. The fastener verification system of claim 1, further comprising attaching an electrical continuity tester to the fastener verification system, wherein a first wire of the electrical continuity tester is attached to the pin and a second wire of the electrical continuity tester is attached to the exposed portion of the housing.

14. The fastener verification system of claim 13, wherein the electrical continuity tester further comprises sending an electrical current through the fastener verification system and detecting continuity.

15. The fastener verification system of claim 14, further comprising classifying an installation of the fastener to the substrate as proper.

16. The fastener verification system of claim 1, further comprising classifying the installation of the fastener to the substrate, wherein the installation is classified as improper when the fastener verification system is disengaged, and wherein the installation is classified as proper when the fastener verification system is engaged.

17. A fastener verification system for determining proper installation of a fastener to a substrate, the fastener verification system comprising:
a housing including;
a connective portion having a slot sized to receive the fastener therein;
an exposed portion opposite the connective portion, the exposed portion including:
a window connecting to an outer end; and
a groove connecting to a planar middle portion;
a shroud disposed between the connective portion and the exposed portion, the shroud defining a bore that extends from a top surface of the housing to a bottom surface of the housing;
wherein the bore matches a contour of a pin,
wherein the top surface defines an upper opening,
wherein the bottom surface defines a lower opening;
a spring pin mechanism including;
the outer end including a bulge extended through the window of the exposed portion;
the planar middle portion connected between the outer end and a hinge;
the pin disposed within the bore of the shroud; and
the hinge connected between the planar middle portion and the pin,
wherein the fastener verification system is disengaged when the pin is entirely disposed within the shroud, and
wherein the fastener verification system is engaged when the pin is exposed outside of the upper opening of the shroud.

18. A method for verifying proper installation of a fastener to a substrate, the method comprising:
attaching a fastener verification system to a fastener, the fastener verification system including:
a housing including;
a connective portion having a slot sized to receive the fastener therein;
an exposed portion opposite the connective portion, the exposed portion having a window; and
a shroud disposed between the connective portion and the exposed portion, the shroud defining a bore that extends from an upper opening of a top surface of the housing to a bottom surface of the housing;
a spring pin mechanism including;
an outer end disposed within the window of the exposed portion
a pin disposed within the bore of the shroud;
a planar middle portion connected between the outer end and a hinge; and
the hinge connected between the planar middle portion and the pin;
installing the fastener to the substrate,
wherein installing the fastener applies a pressure from the substrate against the hinge of the spring pin mechanism,
wherein applying the pressure against the hinge creates movement of the hinge and the pin; and
verifying proper installation of the fastener to the substrate.

19. The method of claim 18, further comprising conducting an electrical continuity test by attaching a tester to the fastener verification system,
wherein the tester including:
a first wire, wherein the first wire attaches to the pin; and
a second wire, wherein the second wire attaches to the exposed portion of the housing,
wherein the tester sends an electrical current through the first wire and the second wire,
wherein the electrical continuity test detects continuity of the electrical current, and
wherein proper installation of the fastener is detected.

20. The method of claim 18, further comprising conducting a visual test, wherein the pin is visible outside of the opening of the shroud and wherein proper installation of the fastener is detected.
